(19) United States
(12) Patent Application Publication
(10) Pub. No.: US 2003/0191662 A1
(43) Pub. Date: Oct. 9, 2003

(54) System and method of mailing

(76) Inventor: Timothy Sean Segrest, Oxford, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/437,828

(22) Filed: May 13, 2003

(51) Int. Cl. G06F 17/60

(52) U.S. Cl. 705/1

(57) ABSTRACT

A system and method of mailing for use by public transportation travelers at security check points, or baggage check-ins, wherein items removed from a traveler's baggage by security personnel as a precautionary or security measure are capable of being mailed to the traveler's residence or other location, instead of having the items burdensomely confiscated by security personnel and forcing the traveler to inconveniently retrieve the items at another date or location, or upon return. Such items may include nail files or nail clipper sets, scissors, pocket knives, and/or any other articles deemed by security personnel to be potentially dangerous, weaponry-like articles generally not permitted aboard a public transport vehicle for security purposes.

### TECHNICAL FIELD

The present invention relates generally to mailing services, and more specifically to a system and method of mailing particularly suitable for, although not strictly limited to, implementation within a public transportation facility for mailing to a traveler's residence those items removed from the traveler's baggage by security personnel.

### BACKGROUND OF THE INVENTION

In view of ongoing terrorist attacks, a vast majority of public transportation facilities have implemented a variety of security measures to ensure the safety of their travelers, passengers and personnel. Specifically, many public transportation facilities, including airports, busing terminals, train stations and/or shuttle services, have instituted security check points and/or baggage check points where a traveler's person and baggage is checked for items or articles that have the potential of causing harm to other travelers or passengers once aboard the public transport vehicle, wherein such articles are generally confiscated upon discovery of same by security personnel.

Unfortunately, non-terrorist, law-abiding travelers who may possess relatively innocuous articles, such as a nail file, grooming scissors or small pocketknife, are generally stripped of such articles as the articles present, at least facially, the potential of being utilized as a weapon. To the traveler's disadvantage, the articles are confiscated, and the traveler is forced to retrieve the articles upon his/her return. As such, the traveler is left inconvenienced by the security check process, and is forced to either replace the confiscated items with new items during his/her journey, or to go without. Such a system bears further ramifications when dealing with an irreplaceable item, perhaps of sentimental value to the traveler, wherein the traveler is left concerned with the safety of the item in the potentially careless hands of security personnel or related staff.

Although the traveler may possess the option of returning the item to his/her vehicle for subsequent retrieval of same upon return, such an option bears obvious inconveniences, and often times, the traveler may have only minutes before he/she must board the public transport vehicle.

Therefore, it is readily apparent that there is a need for a system and method of mailing employable within a public transportation facility, wherein items removed from a traveler's baggage by security personnel are capable of being mailed to the traveler's residence, instead of having the items inconveniently sequestered or confiscated by security personnel for subsequent retrieval by the traveler upon return.

### BRIEF SUMMARY OF THE INVENTION

Briefly described, in a preferred embodiment, the present invention overcomes the above-mentioned disadvantages and meets the recognized need for such a system and method by providing a system and method of mailing for use by airline travelers at airport security check points, or airport baggage check-ins, wherein items removed from a traveler's baggage by airport security as a precautionary or security measure are capable of being mailed to the traveler's residence, instead of having the items burdensomely confiscated by airport security and forcing the traveler to inconveniently retrieve the items at another date or location, or upon return. Such items may include nail files or nail clipper sets, scissors, pocket knives, and/or any other articles deemed by airport security to be potentially dangerous, weaponry-like articles generally not permitted aboard an airplane for security purposes.

According to its major aspects and broadly stated, the present invention in its preferred form is a system and method of mailing providing a mail service conveniently disposed proximal to an airport security checkpoint, or baggage check-in, wherein the mail service provides shipping boxes or cartons, a scale, postage meter, drop box, and mail pick up and delivery service.

More specifically, the present invention is a novel system and method of mailing. Preferably, in one embodiment, the present system and method entails setting up a conveniently located “mailing stand” proximal an airport security checkpoint, thus permitting a traveler to conveniently step out of line and proceed to the mailing stand should an item be removed from his/her bag, wherein the traveler could be directed or monitored by airport security while at the mailing stand. The mailing stand preferably provides a scale for weighing the removed item, a postage meter for dispensing postage according to the weight of the item (i.e., the postage meter preferably possesses conventional payment means for receiving requisite postage fees by the traveler), a vending machine equipped with a variety of differently sized boxes for packaging. the removed item (i.e., weight of the box would be considered during purchase of postage), and a drop box for receiving the packaged item. Items placed within the drop box would then be picked up by the USPS, FEDEX, UPS, or other mail services, for purposes of mailing the item back to the traveler's residence, or other desired location. The entire system is preferably monitored by airport security to prevent abuse of the system, or the mailing of prohibited items, wherein such items would be confiscated, and the passenger dealt with accordingly.

In an alternate embodiment, the present system and method would be implemented at baggage check-in stations. More specifically, should an item at the baggage check-in station be removed from a traveler's bag by airport security, the traveler is given the option of having the item confiscated for retrieval at a later date and location, or to pay a surcharge or insurance payment for having the item mailed back to his/her residence, wherein the insurance payment would cover postage fees, packaging fees and related mailing services. If the latter is chosen, an address label is printed out along with the conventional bag identification sticker label generally appended to a traveler's bag. When the item and bag are transported to the airport loading department or bag check, airport security, or similar agents, meter and package the item and apply the address label thereto, wherein the item is then picked up and mailed to the traveler's residence via USPS, FEDEX, UPS, or other similar mailing services. Should the item be heavier, and thus require more postage than coverable by the insurance charge, the item is preferably delivered to a mail depot located closest to the traveler's residence for convenient retrieval by the traveler upon payment of the additional postage/mailing fees.

Accordingly, a feature and advantage of the present invention is its ability to provide a convenient mailing service employable within a public transportation facility, wherein items removed from a traveler's baggage by security personnel as a security measure are capable of being mailed to the traveler's residence or destination point, instead of being confiscated by security personnel.

Another feature and advantage of the present invention is its inherent establishment of additional security measures within a public transportation facility, as items removed from a traveler's bag are required to either be confiscated or mailed to the traveler's residency, wherein the mailing service is monitored by airport security to prevent abuse of the system, or the mailing of prohibited items, in which case the items would be confiscated and the passenger dealt with accordingly.

Another feature and advantage of the present invention is the establishment of a novel and non-obvious mailing service business method.

Another feature and advantage of the present invention is its ability to permit travelers to conveniently step out of line at a security check point or baggage check-in within a public transportation facility, and mail to a desired residence or destination point those items that have been removed from their baggage by security personnel or the like as a security measure; thus, avoiding the stressful and burdensome task of having to return the item back to the traveler's vehicle or residence prior to boarding the public transport vehicle.

Another feature and advantage of the present invention is its ability to be implemented within any public transportation facility, including, but not limited to, airports, busing terminals, train stations and/or shuttle services.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a plan view of a system and method of mailing. according to a preferred embodiment of the present invention instituted proximal to a security checkpoint within a public transportation facility.

FIG. 2 is a flow diagram of a system and method of mailing according to a preferred embodiment of the present invention instituted proximal to a security checkpoint within a public transportation facility.

FIG. 3 is a flow diagram of a system and method of mailing according to an alternate embodiment of the present invention instituted proximal to a baggage check-in station within a public transportation facility.

### DETAILED DESCRIPTION OF THE PREFERRED AND ALTERNATIVE EMBODIMENTS

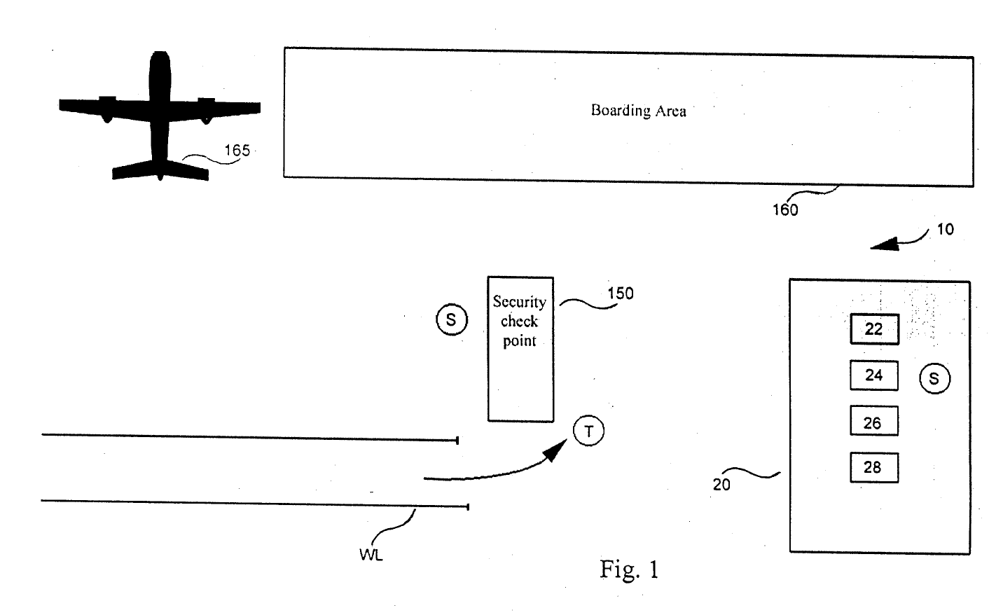

In describing the preferred and alternate embodiments of the present invention, as illustrated in FIGS. 1-3, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIG. 1, the present invention in a preferred embodiment is a system and method of mailing 10, preferably comprising mailing station 20 instituted within public transportation facility 100, proximal to security check point 150, for facilitating the mailing to a traveler's T residence or destination point, those items removed from the traveler's T person or baggage by security personnel S as a precautionary or security measure. Public transportation facility 100 is preferably an airport facility, wherein security check point 150 is preferably a conventional airport security check point commonly positioned proximal to and before boarding area 160. Although public transportation facility 100 is preferably an airport facility, it is contemplated in an alternate embodiment that public transportation facility 100 could be a busing terminal, train station, shuttle service, or the like, wherein system and method 10 could be implemented therein without departing from the appreciative scope of the present invention, as such facilities are in full contemplation of the inventor in describing the present invention herein.

Preferably, mailing station 20 provides the requisite equipment to facilitate mailing of items removed from a traveler's T person and/or baggage, wherein the preferred method of mailing 10 is more fully described below. Preferably, mailing station 20 provides weight scale 22 for weighing the removed item, and postage meter 24 for dispensing postage according to the weight of the item, wherein postage meter 24 preferably possesses conventional payment means for receiving the requisite postage fees by traveler T, such as, for exemplary purposes only, coin deposit, bill deposit, credit card payment means, debit card payment means, or the like. At the selection of and payment by traveler T, postage meter 24 may provide the requisite postage for expedited and/or certified mailing services.

Mailing station 20 further preferably provides vending machine 26 equipped with a variety of differently sized sealable packaging or shipping boxes for packaging a variety of differently sized removed items, wherein each box of vending machine 26 preferably possesses additional postage fees supplied thereon in consideration of the weight of the box, and wherein payment for each box is preferably received via conventional payment means disposed on vending machine 26, such as, for exemplary purposes only, coin deposit, bill deposit, credit card payment means, debit card payment means, or the like. Each box further preferably provides address label areas for indicating mailing destination, as known within the art. Additionally, vending machine 26 preferably provides boxes of varying structural strength, integrity and shape for facilitating. packaging of the removed item, and boxes appropriately labeled for expedited or certified mailings for use with the appropriate postage fees.

Although vending machine 26 preferably provides boxes for packing removed items, it is contemplated in an alternate embodiment that vending machine 26 could provide a variety of mailing supplies, such as, for exemplary purpose only, packaging tape, bubble wrap, packaging material, adhesive labels marked with the word “fragile,” and/or other similar materials to facilitate mailing of the removed item.

Mailing station 20 further preferably provides mail drop box 28 for receiving the packaged item, wherein items placed within mail drop box 28 are preferably picked up or retrieved by a mail service, such as, for exemplary purposes only, USPS, FEDEX, UPS and/or other mail services, contracted or otherwise, for subsequent mailing of the item to traveler's T residence, destination point or other desired location. Mailing drop box 28 is preferably tamper-proof, thus ensuring safety of the deposited item and preventing unauthorized removal of same.

Preferably, the close proximity of mailing station 20 to security checkpoint 150 permits traveler T to conveniently proceed from security checkpoint 150 to mailing station 20 should an item be removed from his/her bag, and thus, enables the traveler T to avoid the stressful and burdensome task of having to return the removed item back to traveler's T vehicle or residence prior to boarding public transport vehicle 165, or to avoid undesired confiscation of same by security personnel S.

Additionally, and as more fully described below, system and method 10 is preferably continuously monitored by security personnel S to prevent abuse thereof, and/or the mailing of prohibited items, wherein such items would be confiscated by security personnel S, and the traveler T dealt with accordingly.

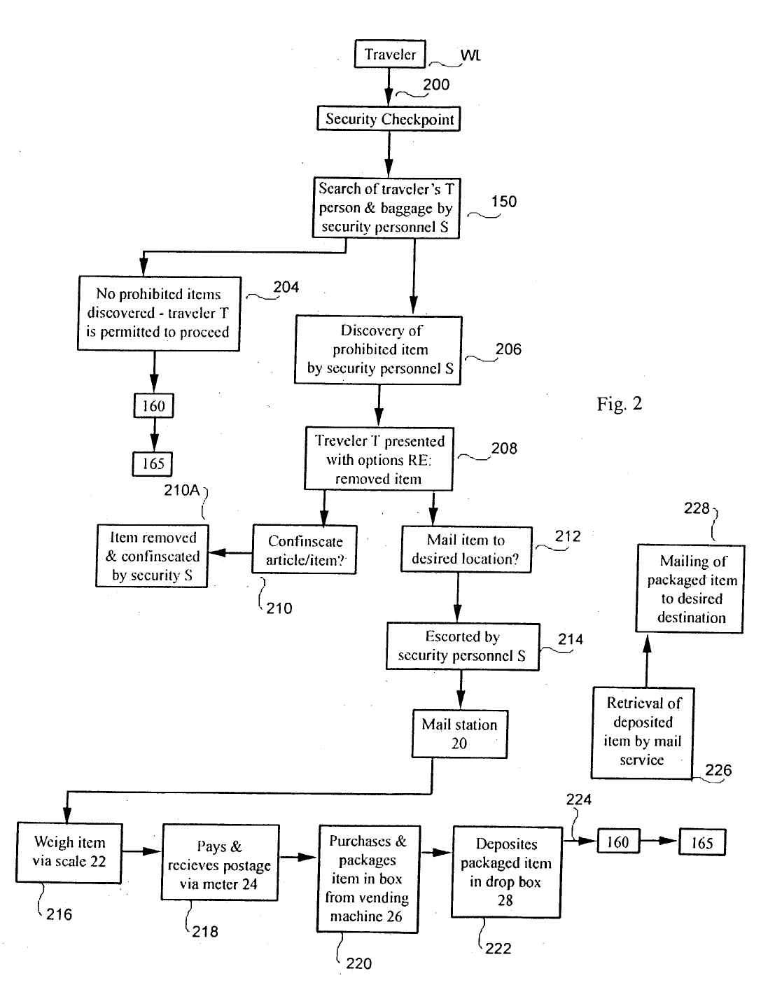

Referring now more specifically to FIG. 2, to implement method of mailing 10, traveler T advances 200 through waiting line WL toward security checkpoint 150, wherein traveler's T person and baggage is subsequently searched 202 by security personnel S for articles or items generally not permitted aboard public transport vehicle 165, such as, for exemplary purposes only, nail files or nail clipper sets, scissors, pocket knives, and/or any other articles deemed by security personnel S to be potentially dangerous, weaponry-like articles requiring confiscation and/or removal for security purposes. If no such prohibited items are discovered by security personnel S, traveler T is permitted to proceed 204 to boarding area 160 for eventual boarding onto public transport vehicle 165.

Upon discovery 206 of a prohibited article by security personnel S, however, traveler T is preferably presented 208 with the option 210 of having the item confiscated by security personnel S for subsequent retrieval at a later date and location, or the option 212 to mail the item to traveler's T residence or destination point. Should traveler T choose option 210, security personnel S preferably removes and confiscates 210A the prohibited item.

If, however, traveler T chooses option 212, traveler T is preferably escorted 214 by security personnel S to mailing station 20, wherein traveler T preferably weighs 216 the removed item via scale 22, receives and pays 218 for postage via postage meter 24, purchases and packages 220 the removed item in a box from vending machine 26, and deposits 222 the packaged item into mail drop box 28, whereupon traveler T is thereafter preferably permitted to proceed 224 to boarding area 160 for eventual boarding onto public transport vehicle 165. Preferably, the deposited item is retrieved 226 by a mailing service such as, for exemplary purposes only, USPS, FEDEX, UPS and/or other mail services, contracted or otherwise, for subsequent mailing 228 of the item to traveler's T desired destination point.

It is contemplated in an alternate embodiment that scale 22, postage meter 24, vending machine 26 and mail drop box 28 could be arranged or configured in any suitable manner that best promotes an efficient procedural or systematic method of mailing 10. It is contemplated in another alternate embodiment that mailing station 20 could be any suitable mailing station, such as, for exemplary purposes only, fully-automated mailing stations, or the like.

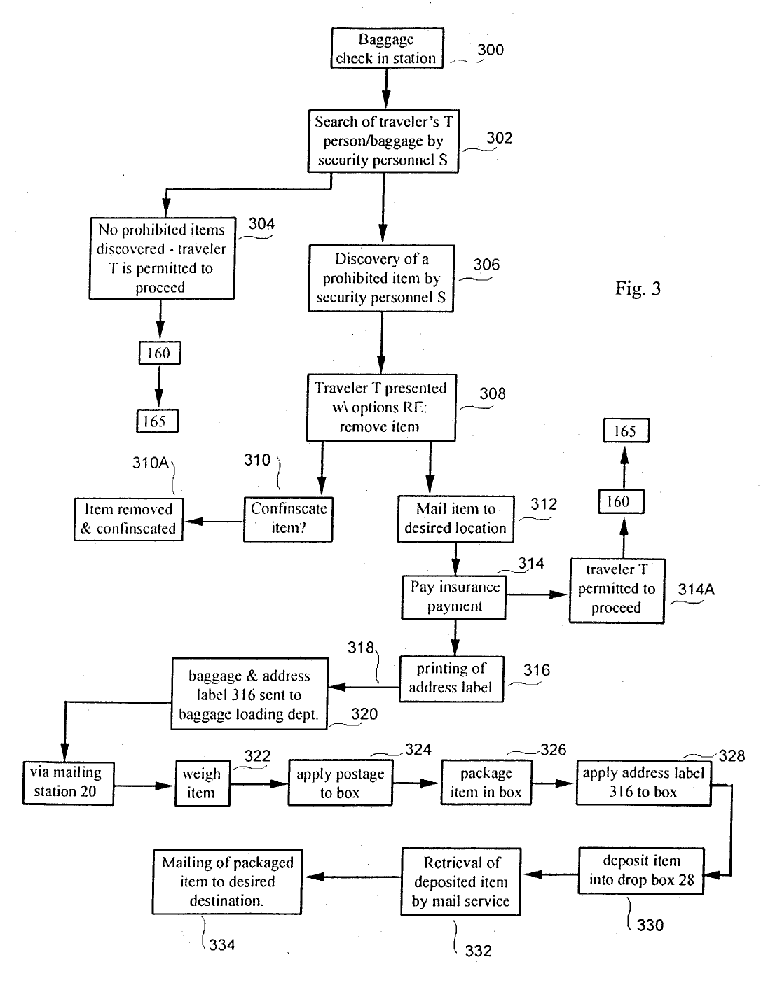

Referring now more specifically to FIG. 3, illustrated therein is an alternate embodiment of system and method 10, wherein the alternate embodiment of FIG. 3 is substantially equivalent in form, function and method to that of the preferred embodiment detailed and illustrated in FIGS. 1-2 except as hereinafter specifically referenced. Specifically, the embodiment of FIG. 3 contemplates implementation of system and method 10 at baggage check-in stations 300 within public transportation facility 100. More specifically, should a search 302 by security personnel S of a traveler's T luggage or bag at baggage check-in station 300 not result in discovery of a prohibited item, traveler T is permitted to proceed 304 to boarding area 160 for eventual boarding onto public transport vehicle 165.

Should, however, a search 302 by security personnel S of a traveler's T luggage or bag at baggage check-in station 300 result in discovery 306 of a prohibited item, traveler T is presented 308 with the option 310 of having the item confiscated for retrieval at a later date or location, or the option 312 of having the removed item mailed to a desired location. Should traveler T choose option 310, security personnel S removes and confiscates 310A the prohibited item.

If, however, traveler T chooses option 312, traveler T is required to pay surcharge or insurance payment 314 for having the item mailed back to his/her residence or desired location, wherein insurance payment 314 covers postage fees, packaging fees and related mailing services, as described below. Upon payment of insurance payment 314 by traveler T, security personnel or related staff stationed at baggage check-in station 300 prints an address label 316 along with the conventional bag identification sticker label generally appended to a traveler's bag, wherein address label 316 preferably designates the desired mailing address as requested by traveler T. Additionally, following payment of insurance payment 314, traveler T is permitted to proceed 314A to boarding area 160 for eventual boarding onto public transport vehicle 165.

Thereafter, the removed item, along with traveler's T baggage and address label 316, is transported 318 to the baggage loading department 320 of public transportation facility 100, wherein security personnel S, baggage handlers, or similar agents, utilize a mailing station 20 to weigh 322 the item, apply 324 the requisite postage to a packaging box, package 326 the item, and apply 328 address label 316 thereto. The packaged item is then deposited 330 into drop box 28 for retrieval 332 by a mailing service such as, for exemplary purposes only, USPS, FEDEX, UPS and/or other mail services, contracted or otherwise, for subsequent mailing 334 of the item to traveler's T desired destination point.

Should the item be heavier, and thus require more postage than coverable by insurance payment 314, it is contemplated that the item could be delivered to a mail depot located closest to traveler's T residence or destination point for convenient retrieval by traveler T upon payment of the additional postage or mailing fees.

It is contemplated in an alternate embodiment that the preferred and alternate embodiments of the present system and method of mailing 10 could also be selectively implemented or interchanged between a security checkpoint and baggage check-in station.

It is contemplated in an alternate embodiment that the preferred and alternate embodiments of the present system and method of mailing 10 could be selectively implemented within any desired facility or setting for convenience purposes, security purposes, or the like.

It is contemplated in an alternate embodiment that the preferred and alternate embodiments of the present system and method of mailing 10 could be selectively monitored by appropriate security personnel to ensure appropriate and legal use thereof.

It is contemplated in an alternate embodiment that the preferred and alternate embodiments of the present system and method of mailing 10 could incorporate any standard and/or accepted operating procedures commonly utilized within conventional mailing facilities to ensure proper mailing of the removed item.

It is contemplated in an alternate embodiment that the preferred and alternate embodiments of the present system and method of mailing 10 could incorporate simple insurance polices to ensure coverage of items lost within the mailing system, as known within the art.

It is contemplated in an alternate embodiment that the preferred and alternate embodiments of the present system and method of mailing 10 could be utilized to effectuate a “last-minute” mailing of any item as desired by traveler T.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A method of mailing capable of being implemented within a public transportation facility, comprising the step of:
a. placing at least one mailing station within close proximity to a security checkpoint of the public transportation facility, wherein a traveler can package and mail selected items to selected locations.

2. The method of claim 1, further comprising the step of removing from a traveler's possession an item not permitted aboard a public transport vehicle of the public transportation facility.

3. The method of claim 2, further comprising the step of presenting to said traveler the option of confiscating said item or mailing said item to a desired location selected by said traveler.

4. The method of claim 3, wherein selection of said option of mailing said item requires said traveler to proceed to said at least one mailing station to mail said item to said desired location.

5. The method of claim 4, further comprising the step of weighing said item at said at least one mailing station to determine appropriate postage.

6. The method of claim 4, further comprising the step of purchasing a packaging box.

7. The method of claim 6, wherein said step of purchasing a packaging box is from at least one vending machine comprising a plurality of packaging boxes.

8. The method of claim 7, further comprising the steps of purchasing and applying said postage to said packaging box and placing said item within said packaging box.

9. The method of claim 8, further comprising the step of depositing said packaged item at said at least one mailing station.

10. The method of claim 9, wherein said packaged item is deposited within at least one mail drop box located within or proximal to said at least one mailing station.

11. The method of claim 10, further comprising the step of retrieving from said at least one mail drop box said packaged item, and mailing said packaged item to said desired location.

12. A method of mailing capable of being implemented within a public transportation facility, comprising the step of:
a. placing at least one mailing station within close proximity to a baggage check-in point of the public transportation facility, wherein a traveler can package and mail selected items to selected locations.

13. The method of claim 12, further comprising the step of removing from a traveler's possession an item not permitted aboard a public transport vehicle of the public transportation facility.

14. The method of claim 12, further comprising the step of presenting to said traveler the option of confiscating said item or mailing said item to a desired location selected by said traveler.

15. The method of claim 14, wherein selection of said option of mailing said item requires said traveler to pay a selected fee to cover mail costs for mailing said item to said desired location.

16. The method of claim 15, further comprising the step of printing an address label having the address of said location thereon.

17. The method of claim 16, further comprising the step of transporting said item and said address label to said at least one mailing station for mailing of said item by one other than said traveler.

18. The method of claim 17, further comprising the step of weighing said item at said at least one mailing station to determine appropriate postage.

19. The method of claim 17, further comprising the step of purchasing a packaging box.

20. The method of claim 19, wherein said step of purchasing a packaging box is from at least one vending machine comprising a plurality of packaging boxes.

21. The method of claim 19, further comprising the steps of purchasing and applying said postage to said packaging box and placing said item within said packaging box.

22. The method of claim 21, further comprising the step of applying said address label to said packaged item.

23. The method of claim 22, further comprising the step of depositing said packaged item at said mailing station.

24. The method of claim 23, wherein said packaged item is deposited within at least one mail drop box located within or proximal to said at least one mailing station.

25. The method of claim 24, further comprising the step of retrieving from said at least one mail drop box said packaged item mailing, and mailing said packaged item to said desired location.

26. A system of mailing capable of being implemented within a public transportation facility, comprising:
placement of at least one mailing station within close proximity to a security checkpoint of the public transportation facility;
implementing a policy of searching a traveler's person and baggage for retrieval from said traveler's possession an item not permitted aboard a public transport vehicle of the public transportation facility; and,
permitting said traveler to mail said item via said at least one mailing station.

27. A system of mailing capable of being implemented within a public transportation facility, comprising:
at least one mailing station positioned proximal to a security checkpoint at the public transportation facility, said at least one mailing station comprising:
means for packaging an item; and,
means for paying for the shipment of said item to a selected location,
wherein a traveler may utilize said at least one mailing station to package and ship selected items to a selected location.
